(19) United States
(12) Patent Application Publication
(10) Pub. No.: US 2024/0241829 A1
(43) Pub. Date: Jul. 18, 2024

(54) APPARATUS AND METHOD FOR CCIX INTERFACE BASED ON USE OF QoS FIELD

(71) Applicant: ELECTRONICS AND TELECOMMUNICATIONS RESEARCH INSTITUTE, Daejeon (KR)

(72) Inventors: Jin-Suk MA, Daejeon (KR); Yoo-Mi PARK, Daejeon (KR); Woo-Jong HAN, Seongnam-si (KR)

(21) Appl. No.: 18/408,642

(22) Filed: Jan. 10, 2024

(30) Foreign Application Priority Data
Jan. 16, 2023 (KR) 10-2023-0006039

(51) Int. Cl. G06F 12/0817; G06F 12/084

(52) U.S. Cl. CPC G06F 12/0828; G06F 12/084

(57) ABSTRACT

Disclosed herein is an apparatus and method for a CCIX interface based on use of a Quality-of-Service (QOS) field. The apparatus includes a host processor operating as a Home Agent (HA) of a CCIX protocol and at least one CCIX port for an interface with at least one computational accelerator operating as a Request Agent (RA) of the CCIX protocol, and CCIX protocol messages may be sent to and received from the at least one computational accelerator through the CCIX port based on the priority preset depending on the type of a command using a QoS field of a CCIX interface format.

### CROSS REFERENCE TO RELATED APPLICATION

This application claims the benefit of Korean Patent Application No. 10-2023-0006039, filed Jan. 16, 2023, which is hereby incorporated by reference in its entirety into this application.

### BACKGROUND OF THE INVENTION

### 1. Technical Field

The disclosed embodiment relates to cache coherent interconnect for accelerators (CCIX) interface technology that is a standard for enabling access to and use of local and remote resources while maintaining cache coherency.

### 2. Description of Related Art

Recently, cutting-edge data-processing applications that need hardware resources exceeding existing computing capacity, such as applications for an earth simulator, construction of a large-scale metaverse, Elasticsearch, risk analysis, beam forming, human genetic analysis, AI application technology, and the like, have emerged all at once.

As an extreme example, the autopilot function used for autonomous vehicles of Tesla is known to operate at a computational speed of 144 TFLOPs (trillion floating-point operations per second) although it is an embedded system, and this requires hardware computation speed approaching the standard of a conventional medium-size computer. Therefore, in order to meet such a hardware requirement, it is essential to parallelize computing nodes, use dedicated accelerators for multiple tasks, and provide a function for massive expansion of memory resources.

In order to respond to the above-mentioned requirement for hardware expansion, the use of GPUs, accelerators, GPGPUs, and the like using a PCI Express (PCIe) method has been attempted.

However, the PCIe method failed in providing a solution to the problem of cache coherency between a cache within a CPU and a cache of extended IO. Also, the PCIe method has a problem in which, although it provides high-speed transfer for bulk data having a size equal to or greater than 16 Kbytes (′bytes' is abbreviated to ‘B’ hereinbelow) by using Direct Memory Access (DMA), high latency is caused when fine-grained data having a size less than 4 KB is transferred.

Furthermore, it is known that the amount of fine-grained data or burst data having a small size accounts for more than 50% of the total amount of data used in the above-mentioned cutting-edge data-processing applications. The continuous use of the PCIe standard for I/O expansion under this condition has been pointed out as a problem. In order to solve this problem, industrial standards such as CCIX, Gen-Z, Open Coherent Accelerator Processor Interface (OpenCAPI), and the like have been recently developed.

The OpenCAPI technology primarily developed by IBM operates at 22 GB/sec. in version 3.0 (using ×8 lanes), but has a problem in which it is applicable only to IBM's Power CPUs. The Gen-Z technology has a problem of high latency even on development boards due to heavy standard protocols. In the end, Gen-Z failed in approaching even close to the target operation speed of 56 GT/sec. per lane, and is absorbed into Compute Express Link (CXL) technology led by Intel, without launching any commercial product.

As part of the development of technology for expanding system resources, the CCIX interface technology, which enables resources to be shared between computing nodes or computational accelerators, is actively being developed by ARM, AMD, and Xilinx.

### SUMMARY OF THE INVENTION

An object of the disclosed embodiment is to send CCIX messages in consideration of hardware characteristics, such as throughput and latency between a main host processor and peripheral devices of CCIX in a system having large-scale resources and using CCIX interface technology, thereby maintaining the Quality of Service (QOS) of the overall CCIX system.

An apparatus for a CCIX interface based on use of a Quality-of-Service (QOS) field according to an embodiment includes a host processor operating as a Home Agent (HA) of a CCIX protocol and at least one CCIX port for an interface with at least one computational accelerator operating as a Request Agent (RA) of the CCIX protocol. CCIX protocol messages may be sent to and received from the at least one computational accelerator through the CCIX port based on a priority preset depending on a type of a command using a QoS field of a CCIX interface format.

Here, the priority for QoS may be in the order of a ‘Dataless’ command, an ‘Atomics’ command, a ‘Reads’ command, and a ‘Writes’ command.

Here, the priority for QoS may be in the order of transfer from the home agent to the request agent and transfer from the request agent to the home agent.

Here, two virtual channels may be formed between the CCIX ports, and the two virtual channels may include a first channel for exchanging data through Direct Memory Access (DMA) and a second channel for exchanging the CCIX protocol.

Here, the host processor may include a System Level Cache (SLC) used as a cache of internal cores, perform synchronization of the SLC, and include at least one CCIX port corresponding to each of the at least one computational accelerator.

Here, the at least one computational accelerator may further include shared memory that is a cache for sharing data with the host processor, an address translation service block for determining a physical memory address of the shared memory by receiving a virtual memory address from the host processor through the CCIX port and for writing data to the shared memory using the determined physical memory address, and a hardware accelerator for processing required data by accessing a location of the shared memory at which writing is completed and for writing a processing result value at a preset address location, and the processing result value may be transferred to the host processor through a Message Signaled Interrupt (MSI) message.

Here, the at least one computational accelerator may operate with a cache hierarchy including an L1 cache and the shared memory, which is an L2 cache, rather than a single piece of shared memory.

Here, the host processor may generate a virtual address and send the same through the CCIX port in order to access the shared memory of the at least one computational accelerator, and may update a system level cache by reading the processing result value from the preset address location of the shared memory when the MSI message including the processing result value is received.

An apparatus for a CCIX interface based on use of a Quality-of-Service (QOS) field according to an embodiment includes a host processor operating as a Home Agent (HA) of a CCIX protocol and a CCIX port for an interface with a slave processor operating as a Slave Agent (SA) of the CCIX protocol. The host processor and the slave processor may be configured as Symmetric Multiple Processors (SMP), the apparatus may further include an additional CCIX port for an interface with a computational accelerator to which a workload of the SMP is offloaded by operating as a Request Agent (RA) of the CCIX protocol, and CCIX protocol messages may be sent/received based on a priority preset depending on a type of a command using a QoS field of a CCIX interface format.

Here, the priority for QoS may be in the order of a ‘Dataless’ command, an ‘Atomics’ command, a ‘Reads’ command, and a ‘Writes’ command.

Here, the priority for QoS may be in the order of transfer from the home agent to the slave agent and transfer from the slave agent to the home agent.

Here, the CCIX port for the interface with the slave processor and a CCIX port of the slave processor may form two virtual channels therebetween, the additional CCIX port for the interface with the computational accelerator and a CCIX port of the computational accelerator may form two virtual channels therebetween, and the two virtual channels may include a first channel for exchanging data through DMA and a second channel for exchanging the CCIX protocol.

Here, the host processor may include local memory, a system level cache shared by cores of the host processor, a CCIX0 port for a CCIX connection with the slave processor, and a CCIX1 port for a CCIX connection with the computational accelerator.

Here, the slave processor may include local memory, a system level cache shared by cores of the slave processor, a CCIX0 port for a CCIX connection with the host processor, and a CCIX1 port for a CCIX connection with the computational accelerator.

Here, the computational accelerator may include a CCIX port for a CCIX connection with the host processor, an additional CCIX port for a CCIX connection with the slave processor, shared memory that is an L2 cache for sharing data with the host processor and the slave processor, an L1 cache, an address translation service block for determining a physical memory address of the shared memory by receiving a virtual memory address from the host processor or the slave processor through the CCIX port or the additional CCIX port and for writing data to the shared memory using the determined physical memory address, and a hardware accelerator for processing required data by accessing a location of the shared memory at which writing is completed and for writing a processing result value at a preset address location.

Here, the host processor and the slave processor may maintain a cache coherency state between system level caches by being connected through the CCIX port.

Here, the host processor may have all system memory maps including the memory map thereof, the memory map of the slave processor, and the memory map of the computational accelerator.

Here, the slave processor may perform operation within a memory map assigned by the host processor and notify the host processor of a change in a memory value that is made as a result of a memory request/response generated within the address range thereof.

Here, in response to notification of the change in the memory value from the slave processor, the host processor may generate a cache snooping packet, thereby automatically updating the system level cache thereof, the system level cache of the slave processor, and the shared memory of the computational accelerator when it is necessary to update cache values due to the change in the memory value.

A method for a CCIX interface based on use of a Quality-of-Service (QOS) field according to an embodiment may include sending/receiving CCIX protocol messages based on a priority preset depending on a type of a command using a QoS field of a CCIX interface format in an interface between a host processor operating as a Home Agent (HA) of a CCIX protocol and another device connected with the host processor through a CCIX port.

### BRIEF DESCRIPTION OF THE DRAWINGS

The above and other objects, features, and advantages of the present disclosure will be more clearly understood from the following detailed description taken in conjunction with the accompanying drawings, in which:

FIGS. 1 to 3 are exemplary views of implementation of a CCIX system;

FIG. 4 is an exemplary view of the structure of a CCIX device for explaining functions of components of a CCIX system;

FIG. 5 is an exemplary view of a basic command request/response structure of a CCIX interface;

FIG. 6 is a view illustrating a read request message format of a CCIX protocol;

FIG. 7 is a view illustrating a write request message format of a CCIX protocol;

FIG. 8 is a configuration diagram of an apparatus for a CCIX interface based on use of a Quality-of-Service (QOS) field according to a first embodiment;

FIG. 9 is a configuration diagram of an apparatus for a CCIX interface based on use of a QoS field according to a second embodiment; and

FIG. 10 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

First, CCIX interface technology to which the present disclosure is applied will be described in detail below.

Development of CCIX interface technology is underway in order to overcome a limitation in which the existing technology such as PCI express (PCIe) used for controlling local and remote shared resources still has a cache coherency problem and to provide flexible interface technology for various resources such as a memory pool, computational accelerators, and the like.

Currently, 20 or more companies with top supply chains, including AMD, ARM, Xilinx, Qualcomm, and the like, are collaborating on the development of a CCIX interface, which is the next-generation system interconnect technology. Also, about 20 research institutions and commercial chip manufacturers are conducting research using CCIX technology. Also, Ampere currently manufactures commercial products that operate at 25 GB/sec. by using CCIX interface PCIe version 4.0 as a physical layer.

### 1. Characteristics of CCIX Protocol

Currently, a method in which, when an arbitrary program is executed, a CPU core causes a load required for execution of the corresponding program to be executed on a dedicated accelerator or a symmetric multiprocessing (SMP) method for executing the load by transferring the load to another CPU core in the same environment is actively being researched.

Here, when the workload of the program is distributed and executed using the dedicated accelerator or the SMP method, a method of distributing the workload via an operating system (OS) by using system calls of the OS was traditionally used. However, departing from the existing method, industrial standard technology that uses hardware logic in order to enable distribution of individual caches and automatic reflection of update content for remote resources without the support of the OS each time the distributed caches are used in a workload is actively being developed.

A hardware-assisted cache synchronization protocol without the intervention of an OS does not suffer from latency resulting from the intervention of the OS or a driver in the OS, so substantial performance improvement of a corresponding application may be expected. A CCIX protocol (referred to as ‘CCIX’ hereinbelow) may be a representative example of such a hardware-assisted cache synchronization protocol.

In addition to the above-mentioned technological advantages, a device supporting CCIX has the following characteristics.

First, CCIX enables expansion and sharing of memory between CCIX devices beyond the memory area installed in a host CPU.

When a CPU and an expansion memory device that support CCIX are connected with each other, the CPU is able to manage the local memory thereof and the expansion memory device supporting CCIX using the same method. That is, the host CPU is able to allocate virtual memory in the expanding memory device using the same method as the method used in the local memory thereof or is able to update the System Level Cache (SLC) thereof when content in the expanding memory area is changed. The hardware-assisted update for the system level cache is the core feature of a CCIX device.

Also, CCIX enables a cache within an accelerator and a cache of a processor to be synchronized with each other without explicit intervention of an OS or driver software and provides a hardware mechanism for accessing data shared between the processor and the accelerator in a consistent manner.

Also, CCIX allows an application to fully manage data in an application system in which a host processor is connected with a memory-attached accelerator through CCIX. That is, when data is transferred from an arbitrary memory node to another one, CCIX enables an application to fully manage the data without the help of an OS.

In terms of the corresponding application, it is important whether the above-described operation can be performed while maintaining a Shared Virtual Memory (SVM) model. The use of CCIX enables the above-described operation to be performed without special software or a process of conversion between a physical memory map and a virtual memory map.

Here, memory location and arrangement on a target side are important issues, but CCIX also provides memory proximity information as a computational entity, and thus additional software support for selecting memory on the target side is not required.

### 2. System Configuration Using CCIX Protocol

The CCIX standard provides a technical method enabling a host to be connected with multiple peripheral I/O devices while maintaining cache coherency. The use of a physical layer of PCI Express (PCIe) is common to all system configurations. Because CCIX operates as an overlay over the physical layer supported by a PCIe transport layer, such as a tree, a mesh, or a ring, any system configuration supported by the PCIe transport layer is possible.

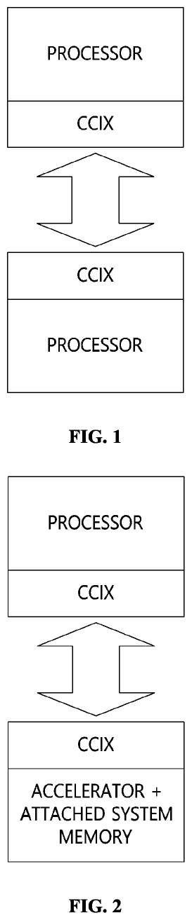

FIGS. 1 to 3 are exemplary views of implementation of a CCIX system.

FIG. 1 is an exemplary view of a system configuration when a host processor and an additional host processor are used by being configured in the form of Symmetric Multiple Processors (SMP).

An example of implementation of the SMP system illustrated in FIG. 1 can be found in a system using a Quick Path Interconnect (QPI) or a Ultra Path Interconnect (UPI) of Intel's processors or a system using AMD's HyperTransport version 1 to version 3.

Because a server processor adopting ARM 64-bit cores cannot use a QPI or a UPI, which is a unique IP of Intel, processors having the SMP architecture by adopting and implementing CCIX, which is the open industrial standard specification, have recently emerged in markets. As representative examples, there are an NISDP development board, which is an ARM's development platform, Altra and Altra Max processors, which are Ampere's commercial processors, and the like.

FIG. 2 is an exemplary view of a configuration in which a host processor is connected with a computational accelerator and memory used by the accelerator using CCIX.

In machine learning, deep learning, and AI computations, which are popular these days, a workload is configured with applications (referred to as ‘kernels’) requiring large-scale operations. In this case, the workload is executed in a distributed manner in such a way that the part requiring the large-scale operation, that is, a kernel, is transferred to and performed by a computational accelerator and a host processor receives the result of the operation and performs a subsequent step.

When the workload is run using a computational accelerator configured with a GPU or an FPGA, rather than CCIX, cache synchronization between memory used by a host processor and memory used by the computational accelerator does not work, so it is necessary to configure a lock table in a software manner in order to use shared memory therebetween, which results in very complicated processes including additional processing and a decrease in computational speed.

When a system is configured using CCIX as shown in FIG. 2, there is an advantage in which data of a workload can be shared, because not only memory attached to a host but also expansion system memory attached to a computational accelerator (attached system memory) can be used as if the attached system memory were the memory area of the host. That is, when the computational accelerator needs data in the host memory in order to perform the operation of a kernel, the computational accelerator does not have to access the host memory, and is able to use the updated data of the host memory in the expansion system memory area thereof without a software synchronization process. This advantage may significantly improve the performance of the system.

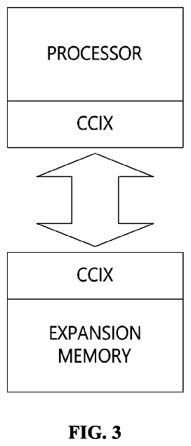

FIG. 3 is an exemplary view of a system configuration having the same effect as if CCIX expansion memory were directly attached to a host processor.

Referring to FIG. 3, the CCIX expansion memory may be used as a peripheral device, which can be used by being configured as part of a memory map of a host system. The expansion memory is used in order to increase the memory capacity of the host system or to provide a function through which a memory type that cannot be supported by the memory controller of the host system can be added using CCIX.

For example, even when the memory controller of the host system cannot support newly emerging High Bandwidth Memory (HBM), HBM2, Non-Volatile Dual In-line Memory Module (NVDIMM), and the like, a function of supporting these devices may be added to and used in the host system by configuring the above-described topology.

Also, the CCIX standard specification states that various forms of topology can be configured using CCIX by mixing the individual system configurations illustrated in FIGS. 1 to 3. However, this departs from the gist of the present disclosure, so a detailed description thereof will be omitted.

### 3. Components Constituting CCIX Architecture

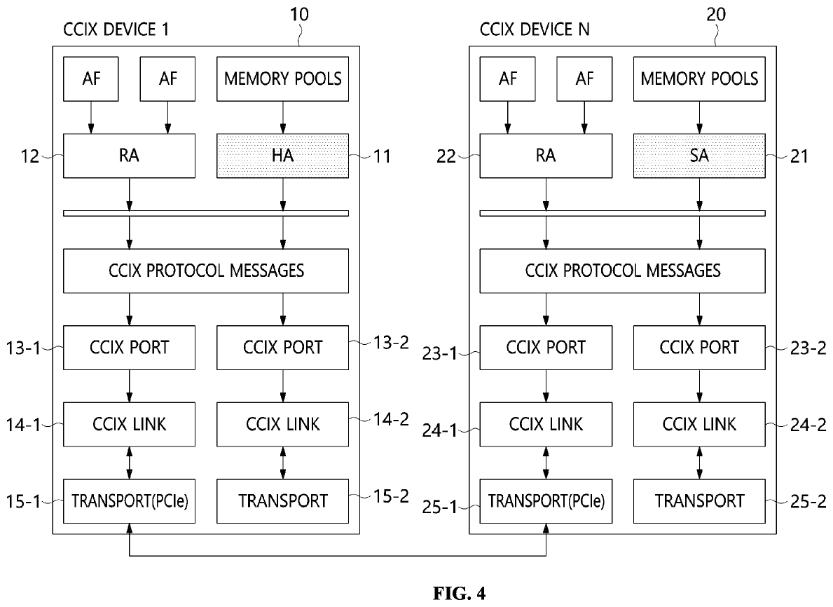

FIG. 4 is an exemplary view of the structure of a CCIX device for explaining the functions of components constituting a CCIX system. However, the configuration of the CCIX device illustrated in FIG. 4 is merely an example for helping the understanding of the present disclosure, and components of a CCIX device may be added or omitted depending on the implemented features of CCIX (e.g., a computational accelerator, a memory pool, and the like).

Referring to FIG. 4, a Home Agent (referred to as ‘HA’ hereinbelow) 11 manages access to memory for a preset address range and cache coherency.

When a cache line is changed, the HA 11 manages synchronization by sending snooping transactions to Request Agents (referred to as ‘RA’ hereinbelow) 12 and 22 that change the cache line. Each CCIX HA 11 acts as a point of cache coherency.

The RAs 12 and 22 generate read and write transactions for addresses within the system. The RAs 12 and 22 may select whether to cache the addressed memory location. The RAs 12 and 22 may have one or more Acceleration Functions (AFs), and the AF is the initiator of the actual transaction.

A Slave Agent (referred to as ‘SA’ hereinbelow) 21 supports expansion of system memory in order to include memory attached to peripheral devices. In this scenario, the home agent 11 may be present in a single arbitrary chip 10, and another agent 21 having the functionality of a home agent and having some or all of the system physical memory may be present in another chip 20. In the CCIX architecture having this configuration, the home agent having the expansion memory should act as a slave agent 21.

The home agent, the role of which is changed to the slave agent, is not allowed to directly access the request generated by the RA 22. In this case, the RA 22 has to access the SA via the HA 10 in another chip 10, thereby accessing the SA 21.

An Error Agent (referred to as ‘EA’ hereinbelow) performs a function of receiving and processing error messages of a CCIX protocol. The protocol error messages may be received from all CCIX components.

CCIX ports 13-1, 13-2, 23-1, and 23-2 function as entry and exit ports for CCIX messages received from an arbitrary CCIX device. Each port should have a transport port connected therewith.

A CCIX link 14-1, 14-2, 24-1, or 24-2 is defined as a link between two CCIX ports. Here, the two CCIX ports should have dedicated resources for communication. When the two CCIX ports communicate with each other, credits are exchanged first in order for a receiving end to receive a message, in which case the credits are required in order to indicate the level of the exchanged resource.

A transport port 15-1, 15-2, 25-1, or 25-2 is a set of physical pins related to the transport of inbound traffic and outbound traffic. A single CCIX port is allowed to receive only one packet at a time from an external chip interface. Also, when it sends a packet to an external chip, the CCIX port is allowed to send only one packet at a time through the transport port.

The components of the CCIX such as those illustrated in FIG. 4 may be applied to various applications. The use of the CCIX interface may create the following effects.

For example, when a computational accelerator supporting CCIX is used by being attached to a host, the computational accelerator may use the same memory map as the memory map seen by a processor.

A general GPU performs a kernel operation based only on addresses of local memory thereof and returns the operation result to a host.

However, a computation accelerator supporting CCIX performs operation with a structural advantage capable of direct access to the cache of a host. For example, a workload, such as packet processing, a graph traversal algorithm, or a key-value database application, requires sharing of fine-grained data having a relatively small size (e.g., data having a size equal to or less than 4 KB, such as 32-byte data, 64-byte data, or the like) on a host, and in this case, the operation speed may be significantly increased.

In another example, when a memory expansion device supporting CCIX is configured and used, a user may implement and use Storage-Class Memory (SCM) having high capacity at relatively low cost. WiredTiger, which is a storage engine within MongoDB, is known to exhibit better performance when it uses the SCM configuration.

In another example, a new Versal device of Xilinx is configured to enable access to and use of Adaptive Compute Acceleration Platforms (ACAP), which load various operation engines into a Field-Programmable Gate Array (FPGA) and use the same by changing the internal memory hierarchy according to need, using CCIX. In response to various workloads, a host is able to access a Versal accelerator at a maximum speed of 25 GT/s and use resources within the Versal accelerator as if they were the native resources of the host.

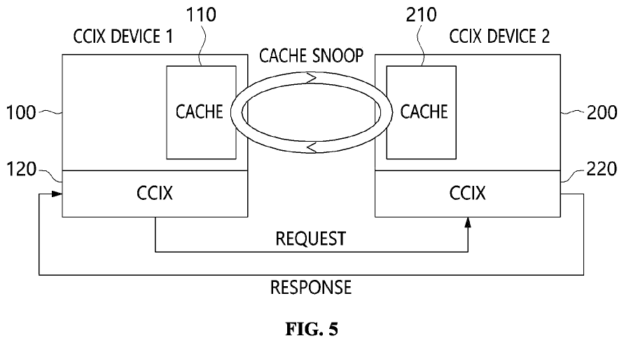

FIG. 5 is an exemplary view of a basic command request/response structure of a CCIX interface.

Referring to FIG. 5, a CCIX interface has a structure including a requester 100 for generating a command and a responder 200 for executing the command by receiving a packet of the corresponding command, whereby the command may be executed.

The command generated by the requester 100 is transferred to the responder 200 in the form of a request through CCIX ports 120 and 220, and when it completes execution of the command, the responder 200 is required to send a response in order to notify the requester 100 of whether execution of the command is completed.

Here, the devices functioning as the requester 100 and the responder 200 are not fixed, and the devices functioning as the requester 100 and the responder 200 may be changed depending on the operation of an application or the environment in which the command is executed.

Also, a cache snoop message, separate from the request and response protocol, is designed to maintain cache coherency in such a way that, when the state of a cache 110 or 210 is changed as the result of the request and response of the CCIX protocol, the changed part is automatically reflected to the other cache.

Meanwhile, according to the CCIX Base Specification Revision 1.1. Version 1.0, messages in CCIX may include the following three messages.
1) Request Message
2) Snoop Message
3) Response Message

Among commands (opcodes) of CCIX, a request message related to the present disclosure will be described, and descriptions of a snoop message and a response message will be omitted because they are not related to the gist of the present disclosure.

An example of the fields of a request message is configured as shown in Table 1 below.

TABLE 1

| | | Width | |
|---|---|---|---|
| Field | Description | (bits) | Comments |
| TgtID | Target Identifier | 6 | |
| SrcID | Source Identifier | 6 | |
| MsgLen | Message Length | 5 | 6 bits for |
| | | | 128B cache line |
| MsgCredit | Message Credit sent | 6 | |
| Ext | Extension included | 1 | |
| MsgType | Message Type | 4 | |
| QoS | QOS Priority Field | 4 | |
| TxnID | Transaction Identifier | 12 | 11 bits for |
| | | | 128B cache line |
| ReqOp | Request Opcode | 8 | |
| Addr | Addr | 58 or 52 | if ExtType = 0->58, |
| The rest | | | ExtType = 1->52 |
| is omitted | | | |

+Definition of fields
-TgtID: Target Identifier associated with the message.
-SrcID: Source Identifier associated with the message.
-MsgLen: Identifies the length of the Message in 4 Byte increments.
-MsgCredit: Identifies if message credits are passed to the sender side of the CCIX Link.
-Ext: If set to 1, indicates inclusion of a 4 Byte extension. When set in an Extension it indicates an additional 4 Byte Extension.
-TxnID: Transaction Identifier associated with the message.

The details of encoded content of the MsgType field, among the request message fields in Table 1, may be as shown in Table 2 below.

TABLE 2

| MsgType [3:0] | Message Type | Credit type used |
|---|---|---|
| 0001 | Memory request | Request only or Request & Data |
| 0010 | Snoop request | Snoop |
| 0011 | Misc (Credited) | Misc |
| 1001 | Memory response | Uncredited |
| 1010 | Snoop response | Uncredited |
| 1011 | Misc (Uncredited) | Uncredited |
| Others | Reserved | |

The details of encoded content of the ReqOp field, among the request message fields in Table 1, may be as shown in Table 3 below.

TABLE 3

| Request Type | ReqOp[7:0] | Request type |
|---|---|---|
| Reads | 0x00 | ReadNoSnp |
| | 0x01 | ReadOnce |
| | 0x02 | ReadOnceCleanInvalid |
| | 0x03 | ReadOnceMakeInvalid |
| | 0x04 | ReadUnique |
| | 0x05 | ReadClean |
| | 0x06 | ReadNotSharedDirty |
| | 0x07 | ReadShared |
| Dataless | 0x10 | CleanUnique |
| | 0x11 | MakeUnique |
| | 0x13 | Evict |
| | 0x14 | CleanShared |
| | 0x15 | CleanSharedPersist |
| | 0x16 | CleanInvalid |
| | 0x17 | MakeInvalid |
| | 0x94 | CleanSharedSnpMe |
| | 0x95 | CleanSharedPersistSnpMe |
| | 0x96 | CleanInvalidSnpMe |
| | 0x97 | MakeInvalidSnpMe |
| Writes | 0x20 | WriteNoSnpPtl |
| | 0x21 | WriteNoSnpFull |
| | 0x22 | WriteUniquePtl |
| | 0x23 | WriteUniqueFulll |
| | 0x24 | WriteBackPtl |
| | 0x25 | WriteBackFullUD |
| | 0x27 | WriteBackFullSD |
| | 0x2B | WriteCleanFullSD |
| | 0x2D | WriteEvictFull |
| Atomics | 0x4X | AtomicStore |
| | 0x5X | AtomicLoad |
| | 0x60 | AtomicSwap |
| | 0x61 | AtomicCompare |
| | 0xCX | AtomicStoreSnpMe |
| | 0xDX | AtomicLoadSnpMe |
| | 0xE0 | AtomicSwapSnpMe |
| | 0xE1 | AtomicCompareSnpMe |
| Chained | 0xF0 | ReqChain |

Here, the ReqOp field may have a value for five request types, and the request types may be defined as follows.

‘Dataless’ is a command that is used when a requester requests permission or ownership for access to a cache line to be used as a target from a responder. Here, a response has no data to be provided to the requester.

‘Reads’ is a data read command.

‘Writes’ is a data write command.

‘Atomics’ is a command for atomic data processing. That is, all interrupts, such as context switching and the like, are suspended, and this command may be processed with the highest priority.

‘Chained’ is a command that enables multiple requests for a cache line to which access is allowed. Accordingly, when this command is executed, the completion time may vary depending on the chained commands.

However, the CCIX Base Specification Revision 1.1 Version. 1.0 specifies that a request message, the ReqOp field of which has a value corresponding to a chained request, does not include a QoS field. Therefore, it can be seen that only the four request types have a QoS field.

According to the CCIX Base Specification Revision 1.1 Version. 1.0, the use and operation of the QoS field are as follows.

First, the QoS field is a field for setting Quality-of-Service (QOS) priority. Here, only a request command has the QoS field. The QoS field does not affect the accuracy of the operation even when it is not set. Also, although the QoS field is not necessarily required for a certain operation, when the QoS field is set to a certain value, the operation is expected to be performed with priority in ascending order of the QoS values.

Also, the QoS field may be used for transaction scheduling of a home or a memory controller.

However, the CCIX specification does not include a use case or guideline of the QoS field.

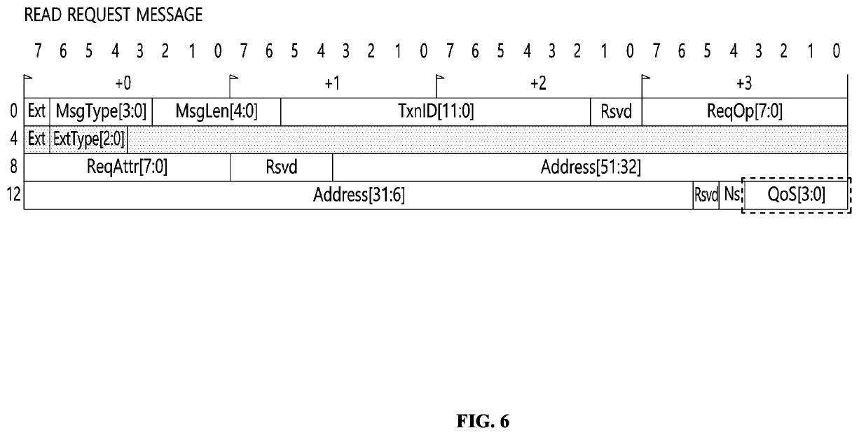

FIG. 6 is a view illustrating a read request message format of a CCIX protocol. Referring to FIG. 6, it can be seen that a QoS field is included.

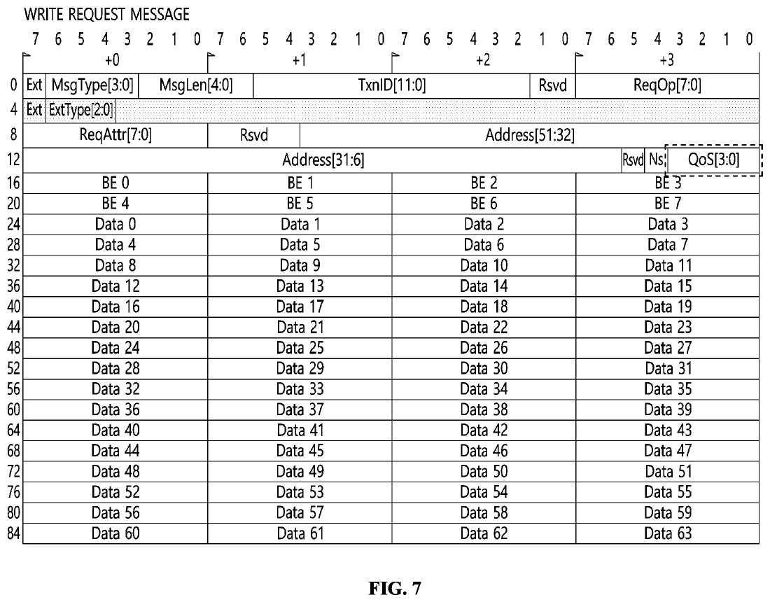

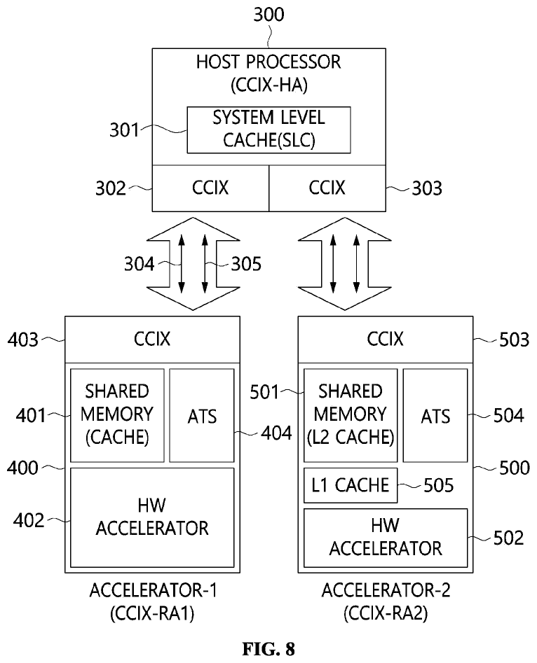

FIG. 7 is a view illustrating a write request message format of a CCIX protocol. Referring to FIG. 7, it can be seen that a QoS field is included.

As described above, CCIX may have various forms of topology, and resources supporting CCIX (computational accelerators, external expanding memory, and the like) may be used by being added to such topology.

The case in which various computational accelerators are installed in a CCIX host (CCIX-HA) that operates with a home agent (HA) function will be described below.

Here, the computational accelerators may have the function of a CCIX-RA, as described above. When a user application (e.g., a workload such as a DBMS) is running on the CCIX host side, the CCIX-HA may generate various transactions depending on read/write operations in the program.

In response to a request message generated by the CCIX-HA, the CCIX-RA may generate a response message. Here, the hardware response characteristics may vary depending on the hardware characteristics of the CCIX-RA, such as the operation speed, a cache level, whether requested data is present, the throughput of the accelerator, and the like.

Also, because response messages generated by the CCIX-RA have different sizes depending on the size of the data requested by the workload, hardware latency varies case by case.

In order to maintain the Quality of Service (QOS) of the overall CCIX system under this condition, the present disclosure proposes technology in which, when a request is generated by setting a different transaction priority level depending on the hardware characteristics of a CCIX-RA, a response signal is generated in consideration of the latency characteristics of the CCIX-RA even when the hardware characteristics or the byte-level sizes of data required by a workload are different, thereby maintaining the QoS.

Here, in order to maintain the QoS in the system, a rule for maintaining bandwidth and throughput and minimizing latency is generally applied.

Application of the rule according to an embodiment may change depending on the system, but a rough priority rule for maintaining the QoS may be as follows.
1) signal message service—an urgent message having the highest priority and a very small packet size (e.g., an interrupt and a control signal)
2) real-time service—a message for a real-time application service (e.g., a video signal, an audio signal)
3) read/write service—a packet for accessing general memory or a register (e.g., general read/write, urgent read/write)
4) block data transfer service—a packet containing very large block-size data and a service that takes a relatively long time to complete (e.g., a cache refill signal, large-scale data transfer using DMA)

An embodiment intends to provide a QoS setting technique that complies with the standard by using the QoS field based on the CCIX interface specification and maintains the high-speed operation state of an application program or an application process by setting priority depending on the type of a command generated in a system based on the CCIX specification and making a CCIX protocol work based on the priority when a large-scale data operation is performed.

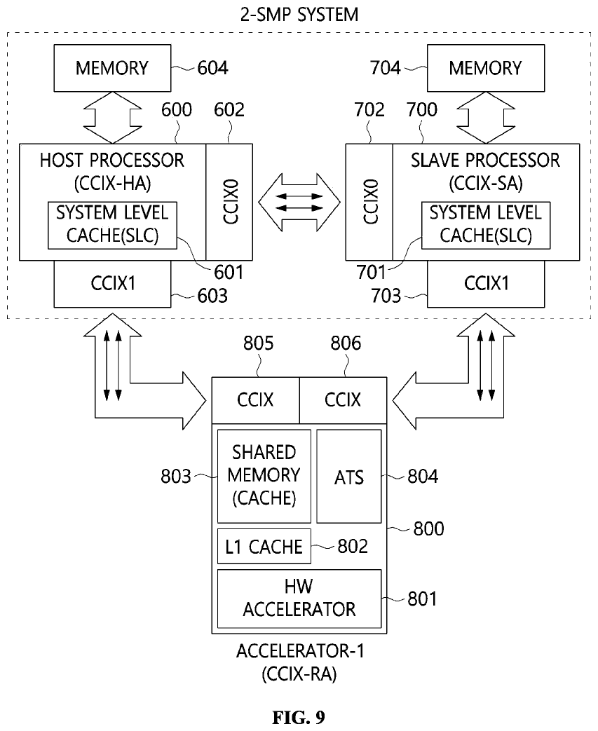

FIG. 8 is a configuration diagram of a CCIX interface device based on use of a QoS field according to a first embodiment.

Referring to FIG. 8, a host processor 300 may perform cache synchronization in a system using the HA function of a CCIX protocol.

A System Level Cache (SLC) 301 is the lowest-level cache of the host processor 300 and is used as the cache of the cores of the host processor 300. Accordingly, when the size of the SLC is 32 MB and when the host processor 300 includes 16 cores, the SLC size per core may be 2 MB.

Here, when two CCIX ports 302 and 303 are installed in the host processor 300, the two CCIX ports 302 and 303 may be physically connected with the CCIX port 403 of a first accelerator 400 and the CCIX port 503 of a second accelerator 500, respectively, through a PCIe.

Here, two virtual channels may be implemented between the CCIX port 302 and the CCIX port 403, and two virtual channels may be implemented between the CCIX port 303 and the CCIX port 503.

Here, the two virtual channels may include a PCIe-DMA channel 304 and a CCIX-HA-RA channel 305.

Here, the PCIe-DMA channel 304 is a virtual channel for exchanging data between the CCIX-HA 300 and the CCIX-RA 400 or 500 through Direct Memory Access (DMA). The CCIX-HA-RA channel 305 is a virtual channel for exchanging a CCIX protocol message.

Meanwhile, the first accelerator Accelerator-1 400 operates as a CCIX-RA, and may exchange a request packet, a response packet, and a snoop packet with the CCIX-HA 300.

Shared memory 401 is cache memory for sharing data with the host processor 300.

An Address Translation Service (ATS) block 404 provides a function for access to the physical memory address of the shared memory 401 using a virtual memory address transferred from the CCIX-HA 300.

Although not illustrated in FIG. 8, the ATS block 404 may include an address translation service function and an ATS switch function.

The ATS block 404 may be implemented in the almost same manner as a PCIe, and this is because a PCIe is used for the physical link of CCIX and because the address translation process is the same as implementation of the PCIe.

That is, when the CCIX-HA 300 generates a virtual address and transfers the same through the CCIX port 302 in order to access the shared memory 401, the CCIX port 403 receives a packet containing the virtual address and transfers the same to the ATS block 404, whereby the physical address of the shared memory 401 is determined. As a result, the process of writing data to the shared memory 401 is performed using the calculated physical address, whereby the data is stored.

When this process is completed, a hardware accelerator 402 fetches required data by accessing the location of the memory to which the data has been written, and puts the data into the engine thereof, thereby processing the data.

When the processing by the hardware accelerator 402 is completed, the result value is written at a preset address location in the shared memory 401, after which this is announced to the host processor 300 using a Message Signaled Interrupt (MSI) message.

The CCIX-HA reads the processed content of the memory in the same manner as before, and, using the result, the CCIX-HA proceeds to the next step of the program.

Here, the processed result value is moved from the location of the shared memory 401 to the SLC 301, whereby the existing value in the SLC is updated. That is, a cache snoop operation occurs, and the cache value of the SLC 301 and the cache value of the shared memory 401 are completely synchronized.

The second accelerator Accelerator-2 500 operates in the almost same manner as described above, but is configured to operate with a cache hierarchy including an L1 cache 505 and shared memory (an L2 cache) 501 in order to increase the operation speed of a hardware accelerator 502.

Generally, multiple levels of caches are known to contribute to increasing the throughput of the hardware accelerator 502.

Assuming that the two computational accelerators 400 and 500 have the same operation speed in order to help the understanding of FIG. 8, a CCIX application system according to the first embodiment may have the following operational characteristics.

First, because it takes additional time to update the SLC of the CCIX-HA, latency in moving write data from the CCIX-RA 400 or 500 to the CCIX-HA 300 is longer than latency in moving write data from the CCIX-HA 300 to the CCIX-RA 400 or 500.

Also, when the CCIX protocol is performed by accessing the second accelerator Accelerator-2 500 having more cache levels, the latency increases compared to when the CCIX protocol is performed by accessing the first accelerator Accelerator-1 400. This is because it is necessary to update all of the caches.

Also, moving data having a size greater than 4 KB in response to a read request from the computational accelerator to the host may cause a significant increase in latency. This may result from the unique characteristics of the CCIX protocol.

Also, when a read request from the computational accelerator to the host is made, a virtual address that is not found in the ATS cache (fails to hit the ATS cache) within the computational accelerator may cause a significant increase in latency due to the address translation time, compared to when the virtual address is found in the ATS cache. This may result from latency caused in the address translation logic.

Finally, an atomic operation generated by the CCIX-HA 300 may be more quickly performed than an atomic operation generated by the CCIX-RA. This is because ARM Advanced extensible Interface (AXI) operation time on the CCIX-RA side is longer.

Therefore, according to the first embodiment, the QoS priority may be set as shown in Table 4 below.

TABLE 4

| QoS | | | | |
|---|---|---|---|---|
| (descending order | | | | |
| of priority) | SrcID | TgtID | ReqOp | Comment |
| 0b1111 | CCIX-HA | CCIX-RA1 | Dataless | |
| 0b1110 | CCIX-HA | CCIX-RA2 | Dataless | |
| 0b1101 | CCIX-RA1 | CCIX-HA | Dataless | |
| 0b1100 | CCIX-RA2 | CCIX-HA | Dataless | |
| 0b1011 | CCIX-HA | CCIX-RA1 | Atomics | |
| 0b1010 | CCIX-HA | CCIX-RA2 | Atomics | |
| 0b1001 | CCIX-RA1 | CCIX-HA | Atomics | |
| 0b1000 | CCIX-RA2 | CCIX-HA | Atomics | |
| 0b0111 | CCIX-HA | CCIX-RA1 | Reads | Request for data having a size equal to |
| | | | | or less than 4 KB |
| 0b0110 | CCIX-HA | CCIX-RA2 | Reads | Request for data having a size equal to |
| | | | | or less than 4 KB |
| 0b0101 | CCIX-HA | CCIX-RA1 | Writes | Request for data having a size equal to |
| | | | | or less than 4 KB |
| 0b0100 | CCIX-HA | CCIX-RA2 | Writes | Request for data having a size equal to |
| | | | | or less than 4 KB |
| 0b0011 | CCIX-RA1 | CCIX-HA | Reads | Request for data having a size greater |
| | | | | than 4 KB |
| 0b0010 | CCIX-RA2 | CCIX-HA | Reads | Request for data having a size greater |
| | | | | than 4 KB |
| 0b0001 | CCIX-RA1 | CCIX-HA | Writes | Request for data having a size greater |
| | | | | than 4 KB |
| 0b0000 | CCIX-RA2 | CCIX-HA | Writes | Request for data having a size greater |
| | | | | than 4 KB |

FIG. 9 is a configuration diagram of an apparatus for a CCIX interface based on use of a QoS field according to a second embodiment.

Referring to FIG. 9, a CCIX application system according to the second embodiment may be configured with two Symmetric Multiple Processors (2-SMP) that use a host processor 600 and a slave processor 700.

According to the second embodiment, the CCIX application system configured with 2-SMP may further include a computational accelerator Accelerator-1 800. That is, a workload of the 2-SMP system is offloaded to the computational accelerator 800.

First, the host processor 600 may include local memory 604 thereof, a system level cache 601 shared by the cores thereof, and a CCIX0 port 602 and a CCIX1 port 603 for a CCIX connection.

The slave processor 700 may include local memory 704 thereof, a system level cache 701 shared by the cores thereof, and a CCIX0 port 702 and a CCIX1 port 703 for a CCIX connection.

An example of this system configuration can be found in a server board using a processor having Ampere's latest ARM cores for server.

Generally, the SMP system improves the operation speed by connecting two or more processors having the same structure through high-speed interconnect logic and by using memory controllers corresponding to multiples of the number of processors while maintaining cache coherency of the system level caches of the processors.

However, the embodiment intends to handle the QoS priority in order to improve the overall system performance in the structure in which the computational accelerator is shared between the processors using CCIX, so the following operation may be added.

The configuration and operation of the computational accelerator 800 illustrated in FIG. 9 are similar to those of the accelerator 500 illustrated in FIG. 8.

However, the computational accelerator 800 is different from the computational accelerator 500 illustrated in FIG. 8 in that it has two CCIX ports 805 and 806 respectively connected to the host processor 600 and the slave processor 700.

Here, like the computational accelerators 400 and 500 illustrated in FIG. 8, the computational accelerator 800 may operate in a CCIX-RA mode.

Meanwhile, when the CCIX0 port 602 is connected with the CCIX0 port 702 in the 2-SMP system, the SLC 601 and the SLC 701 may maintain a cache coherency state.

Here, the host processor 600 may operate as a CCIX-HA, and the slave processor 700 may operate as a CCIX-SA.

In the 2-SMP system, the CCIX-HA has all system memory maps including the memory map thereof, the memory map of the CCIX-SA, and the memory map of the computational accelerator 800.

The slave processor 700 operating as the CCIX-SA performs operation in the memory map assigned by the CCIX-HA, and when there is a change in a value within the address range thereof as a result of a memory request/response, the slave processor 700 has to notify the CCIX-HA of the change.

After it is notified of the change of the memory value of the CCIX-SA, the CCIX-HA generates cache snooping packets, thereby automatically updating cache values in the SLC 601, the SLC 701, and shared memory 803 when it is necessary to update the cache values due to the changed memory value.

Similarly, the host processor 600 or the slave processor 700 may distribute and transfer a workload to the computational accelerator 800, in which case only when the result value of the workload is transferred back to the corresponding processor can the task be completed.

Here, it is necessary to update the SLC of the corresponding processor due to the characteristics of the CCIX.

However, when a value in the SLC is changed in order to complete the operation, latency in processing the update in the SLC 601 may differ from latency in processing the update in the SLC 701. Accordingly, only when CCIX messages are scheduled in consideration of the latency may the QoS characteristic be maintained.

The CCIX application system according to the second embodiment may have the following operational characteristics.

First, the speed of the data transfer between the CCIX-HA and the CCIX-SA is fastest.

Next, latency in write access between the CCIX-HA and the CCIX-SA is longer than latency in read access between the CCIX-HA and the CCIX-SA. This is because it takes time to update the SLC when writing is performed and because additional time may be taken to update the shared memory 803 depending on the cases.

Finally, latency in moving data from the CCIX-SA to the CCIX-RA is longer than latency in moving data from the CCIX-HA to the CCIX-RA. This is because, when it moves data, the CCIX-SA is required to notify the CCIX-HA of this and to update the respective SLCs depending on the processing result.

Therefore, according to the second embodiment, the QoS priority may be set as shown in Table 5 below.

TABLE 5

| QoS | | | | |
|---|---|---|---|---|
| (descending order of | | | | |
| priority) | SrcID | TgtID | ReqOp | Comment |
| 0b1111 | CCIX-HA | CCIX-SA | Dataless | |
| 0b1110 | CCIX-SA | CCIX-HA | Dataless | |
| 0b1101 | CCIX-RA | CCIX-HA | Dataless | |
| 0b1100 | CCIX-RA | CCIX-SA | Dataless | |
| 0b1011 | CCIX-HA | CCIX-SA | Atomics | |
| 0b1010 | CCIX-SA | CCIX-HA | Atomics | |
| 0b1001 | CCIX-RA | CCIX-HA | Atomics | |
| 0b1000 | CCIX-RA | CCIX-SA | Atomics | |
| 0b0111 | CCIX-HA | CCIX-SA | Reads | Request for data having a size |
| | | | | equal to or less than 4 KB |
| 0b0110 | CCIX-SA | CCIX-HA | Reads | Request for data having a size |
| | | | | equal to or less than 4 KB |
| 0b0101 | CCIX-RA | CCIX-HA | Writes | Request for data having a size |
| | | | | equal to or less than 4 KB |
| 0b0100 | CCIX-RA | CCIX-SA | Writes | Request for data having a size |
| | | | | equal to or less than 4 KB |
| 0b0011 | CCIX-HA | CCIX-SA | Reads | Request for data having a size |
| | | | | greater than 4 KB |
| 0b0010 | CCIX-SA | CCIX-HA | Reads | Request for data having a size |
| | | | | greater than 4 KB |
| 0b0001 | CCIX-RA | CCIX-HA | Writes | Request for data having a size |
| | | | | greater than 4 KB |
| 0b0000 | CCIX-RA | CCIX-SA | Writes | Request for data having a size |
| | | | | greater than 4 KB |

Actual implementation of a command set in the embodiment may be realized using Hardware Description Language (HDL) or dedicated logic using an FPGA or dedicated chipset implementing a CCIX interface.

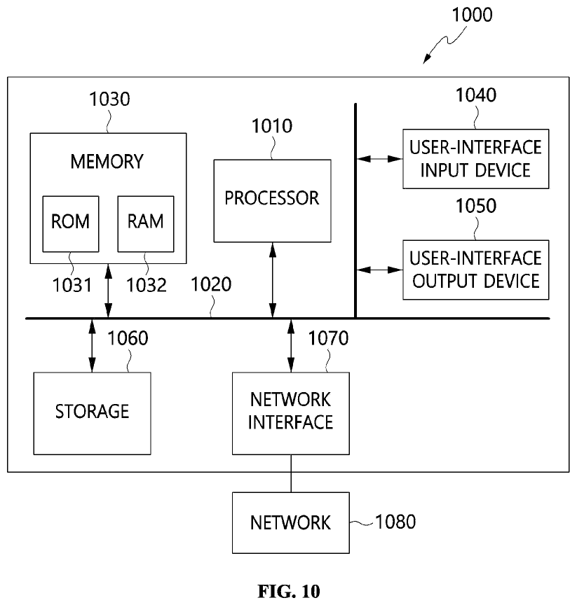

FIG. 10 is a view illustrating a computer system configuration according to an embodiment.

The apparatus according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

The method for a CCIX interface based on use of a QoS field according to an embodiment uses a QoS field of a CCIX interface format in the interface between a host processor operating as a Home Agent (HA) of a CCIX protocol and another device connected therewith through CCIX ports, thereby enabling CCIX protocol messages to be sent/received therebetween based on priority preset depending on the type of a command.

Also, the method for a CCIX interface based on use of a QoS field according to an embodiment may include steps of performing the operations described above with reference to FIG. 8 and FIG. 9.

According to the disclosed embodiment, QoS may be controlled in consideration of the fact that the throughput and latency of a CCIX system vary depending on the method of configuring CCIX I/O, an operating frequency, and the structure of the CCIX system when the CCIX system is configured.

According to the disclosed embodiment, a QoS field in the CCIX standard specification is actively used such that QoS is maintained even when performance varies depending on CCIX components.

According to the disclosed embodiment, a QoS field, a use case or a guideline for which is not mentioned in the CCIX standard specification, may be actively used without changing the CCIX standard specification.

According to the disclosed embodiment, fine-grained data (having a size equal to or less than 4 KB) and coarse-grained data (having a size greater than 4 KB) generated depending on the data size characteristics of a workload may be effectively processed.

According to the disclosed embodiment, because operation can be performed while maintaining QoS characteristics (bandwidth and processing priority determined depending on latency) in workloads for AI applications, Elasticsearch, risk prediction, machine learning and deep learning, largest operational simulation programs, and the like, a bottleneck in the system is resolved, whereby overall throughput improvement may be expected.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. An apparatus for a cache coherent interconnect for accelerators (CCIX) interface based on use of a Quality-of-Service (QOS) field, comprising:
a host processor operating as a Home Agent (HA) of a CCIX protocol; and
at least one CCIX port for an interface with at least one computational accelerator operating as a Request Agent (RA) of the CCIX protocol,
wherein CCIX protocol messages are sent to and received from the at least one computational accelerator through the CCIX port based on a priority preset depending on a type of a command using a QoS field of a CCIX interface format.

2. The apparatus of claim 1, wherein the priority for QOS is in an order of a ‘Dataless’ command, an ‘Atomics’ command, a ‘Reads’ command, and a ‘Writes’ command.

3. The apparatus of claim 2, wherein the priority for QoS is in an order of transfer from the home agent to the request agent and transfer from the request agent to the home agent.

4. The apparatus of claim 1, wherein:
the at least one CCIX port and a CCIX port of the at least one computational accelerator corresponding thereto form two virtual channels therebetween, and
the two virtual channels include a first channel for exchanging data through Direct Memory Access (DMA) and a second channel for exchanging the CCIX protocol messages.

5. The apparatus of claim 1, wherein the host processor includes a System Level Cache (SLC) used as a cache of internal cores, performs synchronization of the SLC, and includes at least one CCIX port corresponding to each of the at least one computational accelerator.

6. The apparatus of claim 1, wherein the at least one computational accelerator includes:
shared memory that is a cache for sharing data with the host processor,
an address translation service block for determining a physical memory address of the shared memory by receiving a virtual memory address from the host processor through the CCIX port and for writing data to the shared memory using the determined physical memory address, and
a hardware accelerator for processing required data by accessing a location of the shared memory at which writing is completed and for writing a processing result value at a preset address location, and
the processing result value is transferred to the host processor through a Message Signaled Interrupt (MSI) message.

7. The apparatus of claim 6, wherein the at least one computational accelerator operates with a cache hierarchy including an L1 cache and the shared memory, which is an L2 cache, rather than a single piece of shared memory.

8. The apparatus of claim 6, wherein the host processor generates the virtual memory address and sends the virtual memory address through the CCIX port in order to access the shared memory of the at least one computational accelerator, and updates a system level cache by reading the processing result value from the preset address location of the shared memory when the MSI message including the processing result value is received.

9. An apparatus for a cache coherent interconnect for accelerators (CCIX) interface based on use of a Quality-of-Service (QOS) field, comprising:
a host processor operating as a Home Agent (HA) of a CCIX protocol; and
a CCIX port for an interface with a slave processor operating as a Slave Agent (SA) of the CCIX protocol,
wherein:
the host processor and the slave processor are configured as Symmetric Multiple Processors (SMP),
the apparatus further includes an additional CCIX port for an interface with a computational accelerator to which a workload of the SMP is offloaded by operating as a Request Agent (RA) of the CCIX protocol, and
CCIX protocol messages are sent/received based on a priority preset depending on a type of a command using a QoS field of a CCIX interface format.

10. The apparatus of claim 9, wherein the priority for QoS is in an order of a ‘Dataless’ command, an ‘Atomics’ command, a ‘Reads’ command, and a ‘Writes’ command.

11. The apparatus of claim 10, wherein the priority for QoS is in an order of transfer from the home agent to the slave agent and transfer from the slave agent to the home agent.

12. The apparatus of claim 9, wherein:
the CCIX port for the interface with the slave processor and a CCIX port of the slave processor form two virtual channels therebetween,
the additional CCIX port for the interface with the computational accelerator and a CCIX port of the computational accelerator form two virtual channels therebetween, and
the two virtual channels include a first channel for exchanging data through Direct Memory Access (DMA) and a second channel for exchanging the CCIX protocol messages.

13. The apparatus of claim 9, wherein the host processor includes:
local memory,
a System Level Cache (SLC) shared by cores of the host processor,
a CCIX0 port for a CCIX connection with the slave processor, and
a CCIX1 port for a CCIX connection with the computational accelerator.

14. The apparatus of claim 9, wherein the slave processor includes:
local memory,
a system level cache shared by cores of the slave processor,
a CCIX0 port for a CCIX connection with the host processor, and
a CCIX1 port for a CCIX connection with the computational accelerator.

15. The apparatus of claim 9, wherein the computational accelerator includes:
a CCIX port for a CCIX connection with the host processor,
an additional CCIX port for a CCIX connection with the slave processor, shared memory that is an L2 cache for sharing data with the host processor and the slave processor,
an L1 cache,
an address translation service block for determining a physical memory address of the shared memory by receiving a virtual memory address from the host processor or the slave processor through the CCIX port or the additional CCIX port and for writing data to the shared memory using the determined physical memory address, and
a hardware accelerator for processing required data by accessing a location of the shared memory at which writing is completed and for writing a processing result value at a preset address location.

16. The apparatus of claim 9, wherein the host processor and the slave processor maintain a cache coherency state between system level caches by being connected through the CCIX port.

17. The apparatus of claim 13, wherein the host processor has all system memory maps including a memory map thereof, a memory map of the slave processor, and a memory map of the computational accelerator.

18. The apparatus of claim 17, wherein the slave processor performs operation within a memory map assigned by the host processor and notifies the host processor of a change in a memory value that is made as a result of a memory request/response generated within an address range thereof.

19. The apparatus of claim 18, wherein in response to notification of the change in the memory value from the slave processor, the host processor generates a cache snooping packet, thereby automatically updating the system level cache thereof, a system level cache of the slave processor, and shared memory of the computational accelerator when it is necessary to update cache values due to the change in the memory value.

20. A method for a cache coherent interconnect for accelerators (CCIX) interface based on use of a Quality-of-Service (QOS) field, comprising:
sending/receiving CCIX protocol messages based on a priority preset depending on a type of a command using a QoS field of a CCIX interface format in an interface between a host processor operating as a Home Agent (HA) of a CCIX protocol and another device connected with the host processor through a CCIX port.
